(19) United States
(12) Patent Application Publication
(10) Pub. No.: US 2023/0011718 A1
(43) Pub. Date: Jan. 12, 2023

(54) WELDING DEVICE AND WELDING METHOD

(71) Applicant: Hilti Aktiengesellschaft, Schaan (LI)

(72) Inventors: Andreas STARZENGRUBER, Bad-Wimsbach-N. (AT); Philipp DÖRNER, Thalheim (AT); Alexander SPEIGNER, Ried im Traunkreis (AT)

(21) Appl. No.: 17/783,901

(22) PCT Filed: Dec. 9, 2020
(86) PCT No.: PCT/EP2020/085279

§ 371 Date: Jun. 9, 2022

(30) Foreign Application Priority Data
Dec. 19, 2019 (EP) 19218010.7

(51) Int. Cl. B23K 9/20; B23K 9/095

(52) U.S. Cl. CPC B23K 9/202; B23K 9/0953; B23K 9/0956; B23K 9/206

(57) ABSTRACT

A device and a method for welding a welding stud to a substrate are disclosed. A welding current is applied to a welding stud between the welding stud and the substrate, whereby a material of the welding stud and the substrate is partially liquefied. The welding stud is then immersed into the solidifying material of the welding stud or the substrate in order to create a bond between the welding stud and the substrate.

### TECHNICAL FIELD

The invention relates generally to a device and to a method for fastening a stud to a substrate and also to such a stud.

### PRIOR ART

There are numerous known devices and methods by which various studs are fastened to a substrate in different applications. For example, a stud is brought into contact with the substrate and an electrical current is applied to it. As soon as the electrical current flows between the stud and the substrate, the stud is lifted off the substrate to form an arc. The energy that is released causes the material of the stud and the substrate to be partially liquefied. The stud is then immersed into the liquefied material before this material cools down and becomes solid. The stud ends up being bonded to the substrate.

In order to provide the necessary energy for liquefying the material of the stud and the substrate in a sufficiently short time, there are known devices that generate an electrical current of a very high intensity and use a correspondingly rated electrical cable to feed it to the stud. To avoid oxidizing of the liquefied material, it is known to surround the area of contact between the stud and the substrate with an inert gas.

In the case of applications in building construction or shipbuilding for example, threaded studs of various sizes to which an item is screwed are used in order to fasten the item to the substrate. Some parameters of the fastening method, such as for example the duration and electrical power of the electrical current, are to be set by a user on the device and are to be adapted to the stud that is used. The user finally assesses the quality of the connection between the stud and the substrate by means of a visual inspection. Therefore, the quality of the connection also depends on the experience and capabilities of the user.

### SUMMARY OF THE INVENTION

The object of the invention is to provide a device and/or a method with which fastening of a stud to a substrate is made easier and/or improved.

The object is achieved in a device for welding a welding stud to a substrate, comprising a stud holder, a welding-current contact element for applying a welding current to the welding stud in order to partially liquefy a material of the welding stud and/or the substrate, a stud transporting device comprising a coil and a determination device for determining a time duration and/or speed of a movement, for example a lifting or immersing movement, of the welding stud and/or a position of the welding stud, in particular before, during or after the lifting and/or immersing movement, the determination device comprising a detection device for detecting an inductance of the coil or a variable representing the inductance of the coil. In addition, the device preferably comprises a stud lifting device for lifting the welding stud off the substrate while maintaining the welding current flowing between the welding stud and the substrate, particularly preferably with the formation of an arc between the welding stud and the substrate. The stud holder likewise preferably comprises the welding-current contact element.

A further advantageous configuration consists in that the stud transporting device comprises a lifting magnet having the coil, which drives the welding stud by means of a magnetic field generated by the coil to perform a lifting movement away from the substrate and/or an immersing movement onto the substrate. A further advantageous configuration consists in that the stud transporting device is formed as a stud lifting device and/or as a stud immersing device.

A further advantageous configuration consists in that the device comprises a control device, which preferably has the determination device. The control device is preferably intended for controlling the stud transporting device in dependence on an inductance or a variable representing the inductance detected by the detection device. The control device is also preferably intended for controlling one or more parameters of the welding operation in dependence on the detected variables. The control device is particularly preferably intended for controlling an electrical voltage and/or a current intensity of the welding current, and/or a speed and/or a position and/or a direction of movement of the welding stud. An advantageous configuration consists in that the control device is suitable for controlling one or more parameters of a subsequent welding operation in dependence on the variables detected by the detection device during a previous welding operation. As a result, under some circumstances it is possible to compensate for the changes in parameters of the welding operation that have been ascertained. As a result, under some circumstances an objective assessment of the quality of the welded connection between the welding stud and the substrate is made possible. A further advantageous configuration consists in that the device comprises a data memory in which a setpoint value for the inductance of the coil or the variable representing the inductance of the coil is stored, the control device being suitable for comparing a variable detected by the detection device with the setpoint value. The control device is preferably suitable for forming a difference between the variable detected by the detection device and the setpoint value.

A further advantageous configuration consists in that the device comprises an output device for outputting information about the variables determined and/or information derived from the variables determined. The output device preferably comprises a visual display and/or a wireless transmission device. The information that can be output by the output device preferably comprises information about a quality of the welding operation and/or about measures to improve the welding operation.

The object is also achieved in a method for welding a welding stud to a substrate, in which a welding stud is provided and a welding current is applied between the welding stud and the substrate, a material of the welding stud and/or the substrate is partially liquefied and allowed to solidify, the welding stud is immersed into the liquefied material of the welding stud or the substrate before it solidifies by means of a stud transporting device comprising a coil, and one or more variables characterizing the immersing movement of the welding stud brought about by the stud transporting device into the liquefied material of the welding stud and/or the substrate are determined, an inductance of the coil or a variable representing the inductance of the coil being detected. The welding stud is preferably lifted off the substrate while maintaining the welding current flowing between the welding stud and the substrate, particularly preferably with the formation of an arc between the welding stud and the substrate. The stud transporting device likewise preferably comprises a lifting magnet comprising the coil, the welding stud being driven by means of a magnetic field generated by the coil to carry out a lifting movement away from the substrate and/or an immersing movement toward the substrate.

An advantageous configuration of the method consists in that a variable detected by the detection device is compared with a setpoint value for the inductance of the coil or the variable representing the inductance of the coil. A difference is preferably formed from the inductance of the coil or the variable representing the inductance of the coil and the setpoint value.

A further advantageous configuration of the method consists in that the stud transporting device is controlled in dependence on an inductance or a variable representing the inductance detected by the detection device.

A likewise advantageous configuration of the method is that one or more parameters of the welding operation are controlled in dependence on the detected variables. An electrical voltage and/or a current intensity of the welding current, and/or a speed and/or a position and/or a direction of movement of the welding stud is preferably controlled.

A further advantageous configuration consists in that one or more parameters of a subsequent welding operation are controlled in dependence on the parameters detected during a previous welding operation.

A further advantageous configuration consists in that information about the variables determined and/or information derived from the variables determined is output. This information is preferably information about a quality of the welding operation and/or about measures for improving the welding operation.

### BRIEF DESCRIPTION OF THE SEVERAL VIEWS OF THE DRAWINGS

The invention will be explained in more detail below on the basis of exemplary embodiments with reference to the drawings, in which:

FIG. 1 schematically shows a welding device,

FIG. 2 schematically shows a welding gun and

FIG. 3 shows a flow diagram of a welding method.

### DESCRIPTION OF THE EMBODIMENTS

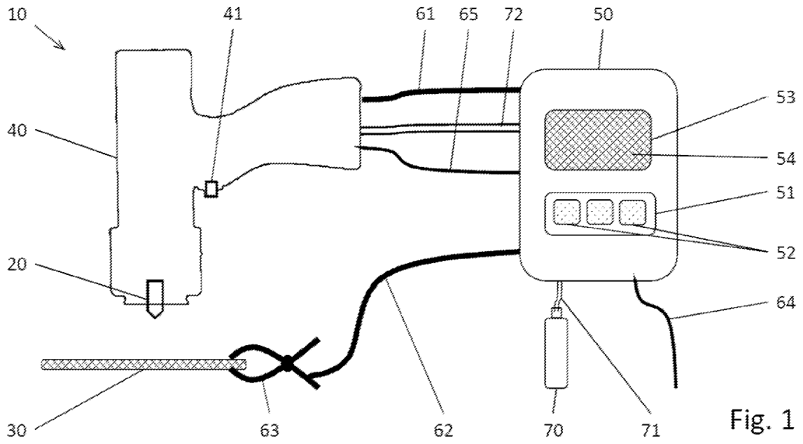

In FIG. 1, a welding device 10 for welding a welding stud 20 to a substrate 30 is schematically represented. A material of the welding stud 20 and a material of the substrate 30 are electrically conductive, in particular metallic. The welding device 10 comprises a welding gun 40 with a trigger switch 41, formed as a pushbutton switch, a welding unit 50, a first electrical cable 61, a second electrical cable 62 with a connection terminal 63, an electrical supply cable 64, formed for example as a power cable, an electrical communication line 65, a gas reservoir 70, formed as a gas cylinder, a tubular gas supply line 71 and a gas hose 72.

The first cable 61 serves for supplying the welding stud 20 with electrical current through the welding unit 50. The second cable 62 serves for electrically connecting the substrate 30 to the welding unit 50 when the connection terminal 63 is clamped to the substrate 30. When the welding stud 20 comes into contact with the substrate 30, a circuit closes, so that welding current, for example in the form of direct current or alternating current, can be applied to the welding stud 20 through the welding unit 50. For this purpose, the welding gun 40 comprises a welding-current contact element that is not shown in FIG. 1. The welding unit 50 comprises a device that is not shown for converting electrical current from the supply cable 64 into welding current, which comprises for example an electrical capacitor, a thyristor, a bipolar transistor with an isolated gate electrode or other components from power electronics and also an associated control unit with a microprocessor, in order to provide the welding current at the desired voltage and current intensity.

The gas supply line 71 and the gas hose 72 serve for supplying a contact region between the welding stud 20 and the substrate 30 with an inert gas from the gas reservoir 70, in order to protect the contact region from oxidation due to oxygen from a surrounding area during a welding operation. For controlling a gas flow to the contact region, the gas reservoir 70, the gas supply line 71, the welding unit 50, the gas hose 72 or the welding gun 40 comprises a valve (not shown), in particular a controllable valve.

The welding unit 50 has an input device 51 having actuating elements 52, and an output device 53 having a visual display element 54 and a wireless transmission unit. The input device 51 serves for the input of parameters of a welding method to be carried out with the welding device 10, for example the electrical voltage, current intensity, power and time duration of the welding current, position and speed of the stud and so on, by a user of the welding device 10. The output device 53 serves to output information to the user, for example information about parameters of the welding method, information about detected emissions of the welding method or other variables, information about a quality of the welding operation, information about measures for improving the welding operation, information about detected characteristics of the welding stud, or information derived from the aforementioned variables, and/or recommendations or instructions for cleaning and/or maintaining the welding device 10, in particular the welding gun 40.

The communication line 65 serves for communication between the welding gun 40, in particular a control device of the welding gun 40 that is not shown in FIG. 1, and the welding unit 50, in particular the control unit and/or the input device 51 and/or the output device 53. By way of this communication, for example an exchange of information about the parameters of a welding operation is accomplished, in order for example to achieve synchronization of the welding current with a movement of the welding stud 20 or to make this easier. In exemplary embodiments that are not shown, the communication between the welding gun and the welding unit takes place wirelessly, by radio or by means of the first electrical cable, which carries the welding current.

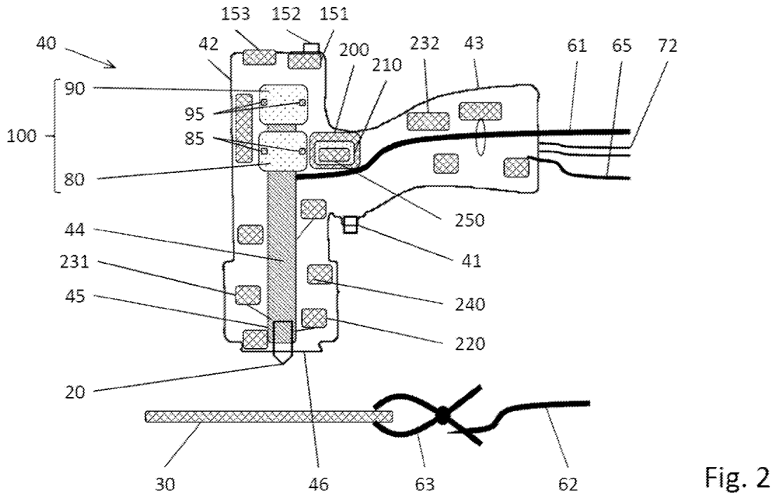

In FIG. 2, the welding gun 40 is shown in more detail, with the welding stud 20 for fastening to the substrate 30. The welding gun 40 has a housing 42 with an opening 46, a handle 43 having the trigger switch 41 protruding from said housing 42. Also shown are the first electrical cable 61, the second electrical cable 62 with the connection terminal 63 clamped to the substrate 30, the electrical communication line 65 and the gas hose 72. The welding gun 40 also has a stud holder 44, on which the welding stud 20 is held during a welding operation. For this purpose, the stud holder comprises for example two, three, four or more resilient arms (not shown in detail), between which the welding stud 20 is inserted and held by means of a clamping fit. The welding gun 40 also has for applying a welding current to the welding stud 20 a welding-current contact element 45, which is integrated in the stud holder 44, for example in the form of one or more of the resilient arms.

The welding gun 40 also has a control device 200 for controlling the various components and devices of the welding gun and of the welding unit 50. The control device 200 is intended for controlling one or more parameters of the welding operation. For this purpose, the control device 200 comprises various electronic components, such as for example one or more microprocessors, one or more temporary or permanent data memories, and the like.

The welding gun 40 also comprises a stud transporting device 100, which has a stud lifting device 80, formed as a first lifting magnet, and a stud immersing device 90, formed as a second lifting magnet. The stud lifting device 80 has a first coil 85 and acts on the stud holder 44 with a force away from the opening 46 to the rear (upwardly in FIG. 2) when the stud lifting device 80 is activated, by the first coil 85 being energized and for example exerting a reluctance force on a soft magnetic material of the stud holder 44 by means of a magnetic field. For this purpose, the stud holder 44 has for example a first iron or steel ring (not shown) on its outer circumference. Via a signal line that is not shown, the control device 200 communicates with the stud lifting device 80 in order to control the stud lifting device 80, in particular to activate and deactivate it.

The stud immersing device 90 has a second coil 95 and acts on the stud holder 44 with a force toward the opening 46 to the front (downwardly in FIG. 2) when the stud immersing device 90 is activated, by the second coil 95 being energized and for example exerting a reluctance force on a soft magnetic material of the stud holder 44 by means of a magnetic field. For this purpose, the stud holder 44 has for example a second iron or steel ring (not shown) on its outer circumference. Via a signal line that is not shown, the control device 200 communicates with the stud immersing device 90 in order to control the stud immersing device 90, in particular to activate and deactivate it. In the case of an exemplary embodiment that is not shown, the stud immersing device is formed as a spring element which is tensioned when the stud holder is moved rearward by the stud lifting device and which moves the stud holder forward as soon as the stud lifting device is deactivated.

The welding gun 40 also has an identification device 220 for detecting one or more stud characteristics of the welding stud 20. Via a signal line that is not shown, the control device 200 communicates with the identification device in order to receive signals representing the detected stud characteristics and to carry out the control of the welding operation accordingly. In the case of an exemplary embodiment that is not shown, the identification element is attached to a packaging of the welding stud and is read, for example by way of a QR code or RFID, in particular by means of a cell phone or similar device.

The welding gun 40 also comprises a voltage detection device 231 for detecting an electrical voltage applied between the welding stud 20 and the substrate 30 during the welding operation and a current-intensity detection device 232 for detecting an intensity of a current flowing between the welding stud 20 and the substrate 30 during the welding operation. For this purpose, the voltage detection device 231 preferably comprises a measuring contact, for example mounted at the opening 46, for tapping the electrical potential of the substrate 30. Via a signal line that is not shown, the control device 200 communicates with the voltage detection device 231 and the current-intensity detection device 232 in order to receive signals representing the electrical voltage or current intensity, store them in one of their data memories and control one or more parameters of a subsequent welding operation in dependence on the parameters detected by the detection devices 231, 232 during a previous welding operation.

The welding gun 40, in particular the control device 200, comprises a determination device 210 for determining a time duration and/or speed of a movement, for example a lifting or immersing movement, of the welding stud and/or a position of the welding stud before, during or after the lifting and/or immersing movement. The determination device 210 in turn comprises a detection device 250 for detecting an inductance of the first coil 85 and/or the second coil 95 or a variable which represents an inductance of the first coil 85 and/or the second coil 95. Since the inductance of the first coil 85 and the second coil 95 is influenced by a position of the stud holder 44, and thus of the welding stud 20, it is possible to draw a conclusion from the detected inductance about the position of the welding stud 20. To detect the inductance of the coil 85, 95, the detection device 250 applies an electrical current to the coil 85, 95, which is switched off again after a predetermined period in order to wait for a steady state, whereby a free-wheeling phase begins, in which the electrical current decreases until it falls below a reference value. A time duration of the free-wheeling phase is proportional to the inductance of the coil 85, 95, and thus represents a variable representing the inductance. In order to determine the position of the welding stud 20, the determination device 210 uses stored values which are detected at one or more calibration positions of the welding stud 20. Possible calibration positions include for example a position of the welding stud 20 before it is placed on the substrate, after it has been placed on it and before the welding operation, after the welding operation and the like.

The control device 200 is suitable for deriving a difference between the two positions of the welding stud 20 determined by the determination device 210 before the lifting movement or after the immersing movement, and thus assessing the quality of the welded connection between the welding stud 20 and the substrate 30. In addition, the control device 200 is suitable for controlling the stud transporting device 100 and/or one or more parameters of the welding operation, such as for example an electrical voltage and/or a current intensity of the welding current, and/or a speed and/or a position and/or a direction of movement of the welding stud 20 in dependence on a variable determined by the determination device 210, and thus in dependence on an inductance or a variable representing the inductance detected by the detection device 250. The control device 200 is preferably suitable for controlling one or more parameters of a subsequent welding operation in dependence on the variables determined by the determination device 210 and/or detected by the detection device 250 during a previous welding operation. This allows a compensation of the changes in parameters of the welding operation that have been ascertained as well as an objective assessment of the quality of the welded connection between the welding stud and the substrate. A setpoint value for the inductance of the coils 85, 95 or the variables representing the inductance of the coils 85, 95 is stored in a data memory of the control device 200. The control device 200 is suitable for comparing a variable detected by the detection device 250 with the setpoint value and forming a difference between the variable detected by the detection device 250 and the setpoint value and compensating for this in subsequent welding operations.

The welding gun 40 also has an input device 151 with an actuating element 152 and also an output device 153 with a visual display element and a wireless transmission unit. The control device 200 communicates with the input device 151 and the output device 153 via signal lines that are not shown, to receive information input by means of the input device 151 or to send information to be output to the output device 153.

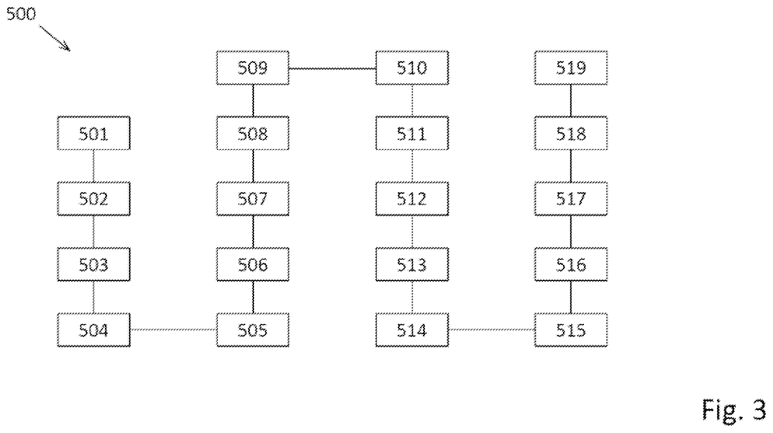

FIG. 3 schematically shows a method 500 for welding a welding stud to a substrate, for example the welding stud 20 to the substrate 30. In a first step 501, the substrate is provided. In a further step 502, a welding device with a control device is provided. In a further step 503, a welding stud is provided.

In a further step 504, information, for example about desired parameters of the following welding operation, are input by a user via an input device. In a further step 505, one or more stud characteristics of the welding stud are detected by means of an identification device. In a further step 506, information about the detected stud characteristics and/or information derived from the detected stud characteristics is output via an output device.

In a further step 507, a welding current is applied to the welding stud between the welding stud and the substrate. In a further step 508, the welding stud is lifted off the substrate by means of a stud lifting device while maintaining the welding current flowing between the welding stud and the substrate, an arc forming between the welding stud and the substrate. In a further step 509, a material of the welding stud and/or the substrate is partially liquefied, in particular due to the heat generated by the arc. In a further step 510, the welding stud is immersed into the liquefied material of the welding stud or the substrate by means of a stud immersing device. In a further step 511, one or more parameters of the welding operation are controlled. In a further step 512, emissions generated during the welding operation are detected by means of a detection device. In a further step 513, one or more parameters of the welding operation are determined. In a further step 514, the liquefied material of the welding stud and/or the substrate solidifies, so that the welding stud is bonded to the substrate. In a further step 515, one or more parameters of the welding operation and an inductance of a coil or a variable representing the inductance of the coil are detected and stored by means of one or more detection devices. The welding stud is preferably driven by means of a magnetic field generated by the coil in order to carry out a lifting movement away from the substrate and/or an immersing movement toward the substrate.

In a further step 516, parameters detected by the one or more detection devices during a current welding operation are compared with parameters or setpoint values stored in a data memory, and differences between the parameters detected by the detection device during the current welding operation and the parameters stored in the data memory and/or information derived from such differences are output. In a further step 516, one or more parameters of a subsequent welding operation are controlled in dependence on the parameters detected during a previous welding operation. In a further step 517, information is output via an output device. In a further step 518, after a welding operation has been carried out, an assessment of a quality of the welding operation is input by a user. In a further step 519, an input by the user is used to assess a quality of future welding operations.

The invention has been described on the basis of examples of a device and a method for welding a welding stud to a substrate. The features of the described embodiments can also be combined as desired with one another within a single welding device or a single welding method. It should be noted that the device according to the invention and the method according to the invention are also suitable for other purposes.

1. A device for welding a welding stud to a substrate, the device comprising a stud holder, a welding-current contact element for applying a welding current to the welding stud to partially liquefy a material of the welding stud and/or the substrate, a stud transporting device comprising a coil and a determination device for determining a time duration and/or speed of a movement of the welding stud and/or a position of the welding stud, the determination device comprising a detection device for detecting an inductance of the coil or a variable representing the inductance of the coil.

2. The device as claimed in claim 1, the stud transporting device comprising a lifting magnet having the coil, which drives the welding stud by a magnetic field generated by the coil to perform a lifting movement away from the substrate and/or an immersing movement onto the substrate.

3. The device as claimed in claim 1, the stud transporting device comprising a stud lifting device for lifting the welding stud off the substrate.

4. The device as claimed in claim 1, the stud transporting device comprising a stud immersing device for immersing the welding stud into the liquefied material of the welding stud and/or the substrate when the welding stud and/or the substrate is partially liquefied due to the welding current.

5. The device as claimed in claim 1, further comprising a control device.

6. The device as claimed in claim 5, further comprising a data memory in which a setpoint value for the inductance of the coil or the variable representing the inductance of the coil is stored, the control device being suitable for comparing a variable detected by the detection device with the setpoint value.

7. The device as claimed in claim 5, the control device being intended for controlling the stud transporting device in dependence on an inductance or a variable representing the inductance detected by the detection device.

8. The device as claimed in claim 5, the control device being intended for controlling one or more parameters of the welding operation in dependence on the detected variables.

9. The device as claimed in claim 8, the control device being intended for controlling an electrical voltage and/or a current intensity of the welding current, and/or a speed and/or a position and/or a direction of movement of the welding stud.

10. A method for welding a welding stud to a substrate, the method comprising
a) providing a welding stud,
b) applying a welding current to the welding stud between the welding stud and the substrate,
c) partially liquefying a material of the welding stud and/or the substrate,
d) immersing the welding stud into the liquefied material of the welding stud or the substrate before the liquefied material solidifies by a stud transporting device comprising a coil,
e) determining one or more variables characterizing the immersing movement of the welding stud brought about by the stud transporting device into the liquefied material of the welding stud and/or the substrate, and
f) detecting an inductance of the coil or a variable representing the inductance of the coil.

11. The method as claimed in claim 10, wherein the stud transporting device comprises a lifting magnet comprising the coil, the method including driving the welding stud by a magnetic field generated by the coil to carry out a lifting movement away from the substrate and/or an immersing movement toward the substrate.

12. The method as claimed in claim 10, including comparing a variable detected by the detection device with a setpoint value for the inductance of the coil or the variable representing the inductance of the coil.

13. The method as claimed in claim 10, the stud transporting device being controlled in dependence on an inductance or a variable representing the inductance detected by the detection device.

14. The method as claimed in claim 10, including controlling one or more parameters of the welding operation in dependence on the detected variables.

15. The method as claimed in claim 14, including controlling an electrical voltage and/or a current intensity of the welding current, and/or a speed and/or a position and/or a direction of movement of the welding stud.

16. The device of claim 5, wherein the control device comprises the determination device.

17. The device of claim 6, wherein the control device is suitable for comparing the variable detected by the detection device with the setpoint value for forming a difference from the variable.

18. The method of claim 12 including comparing the variable detected by the detection device with the setpoint value for forming a difference from the variable.

19. The device as claimed in claim 2, the stud transporting device comprising a stud lifting device for listing the welding stud off the substrate.

20. The device as claimed in claim 2, the stud transporting device comprising a stud immersing device for immersing the welding stud into the liquefied material of the welding stud and/or the substrate when the welding stud and/or the substrate is partially liquefied due to the welding current.
